(19) United States
(12) Patent Application Publication
(10) Pub. No.: US 2023/0281278 A1
(43) Pub. Date: Sep. 7, 2023

(54) Software License Management Platform

(71) Applicant: People Center, Inc., San Francisco, CA (US)

(72) Inventors: Miguel Fernandez Garcia, San Francisco, CA (US); Balram Khichar, Sikar (IN); Adam Vy Donovan, San Francisco, CA (US)

(21) Appl. No.: 17/687,249

(22) Filed: Mar. 4, 2022

(51) Int. Cl. G06F 21/10; G06F 11/34; G06F 21/64

(52) U.S. Cl. CPC G06F 21/105; G06F 11/3438; G06F 21/645; G06F 2221/0757; G06F 2221/0713

(57) ABSTRACT

Provided are systems, devices, computer-implemented methods, and tangible non-transitory computer readable media for managing software licenses for an organizational entity, such as a business. In particular, examples described in the present disclosure enable the organizational entity to efficiently identify software licenses and subscriptions that are in use, are inactive, are not being used, and/or are associated with users no longer employed by the organizational entity. Examples described in the present disclosure also enable the organization to efficiently (e.g., automatically) manage the identified software licenses and subscriptions, such as canceling licenses and subscriptions for accounts no longer active or in use, identifying users not actively using licenses and subscriptions and modifying or removing the license or subscription, determining overall utilization of licenses and subscriptions across the organizational entity, and the like.

### FIELD

The present disclosure generally relates to computer systems. More particularly, the present disclosure relates to a software license management system.

### BACKGROUND

Various organizational entities, such as businesses, work teams, schools, agencies, non-profits, and other organizations, utilize third-party software applications to provide different services for users associated with the organizational entity, such as computer code management services, e-mail services, word processing services, workflow management services, customer relationship management services, team communication services, and the like. In order to access these third-party software applications, organizational entities may have to pay licensing fees or purchase subscription plans. For entities providing access to third-party software applications to a large number of workers, the cost to provide access for each worker to every third-party software application can be expensive, sometimes prohibitively so. Furthermore, some workers may not utilize or may underutilize some or all of the third-party software applications licensed by or subscribed to by the entity, which represents monetary waste by the entity, time waste implementing the third-party software application for a user that will not utilize the application, processing and memory waste creating and storing data for the user, and the like.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for managing a plurality of software licenses. The method includes receiving, from an organizational management platform, data descriptive of a plurality of platform user accounts. The method includes receiving, from a third-party software application, data descriptive of a plurality of application user accounts. The method includes matching at least one platform user account of the plurality of platform user accounts to at least one application user account of the plurality of application user accounts. The method includes determining, for a software license associated with the at least one application user account, a use status of the software license based on data associated with the application user account. The method includes associating the use status of the software license with the at least one platform user account matched with the at least one application user account. The method includes providing a user interface for display, the user interface indicating the use status of the software license in association with the platform user account.

Another example aspect of the present disclosure is directed to a non-transitory, computer-readable medium comprising instructions that, when executed by one or more processors, cause the one or more processors to perform operations. The operations include receiving, from an organizational management platform, data descriptive of a plurality of platform user accounts. The operations include receiving, from a third-party software application, data descriptive of a plurality of application user accounts. The operations include matching at least one platform user account of the plurality of platform user accounts to at least one application user account of the plurality of application user accounts. The operations include determining, for a software license associated with the at least one application user account, a use status of the software license based on data associated with the application user account. The operations include associating the use status of the software license with the at least one platform user account matched with the at least one application user account. The operations include providing a user interface for display, the user interface indicating the use status of the software license in association with the platform user account.

Another example aspect of the present disclosure is directed to a computing system having one or more processors that are communicatively coupled to one or more non-transitory computer-readable media with instructions that, when executed by the one or more processors, cause the one or more processors to perform operations for matching user accounts across multiple third-party software applications. The operations include receiving, from a first third-party software application, data descriptive of a first application user account associated with a user. The operations include receiving, from an organization management platform, data descriptive of a platform user account associated with the user. The operations include matching a second application user account for a second third-party software application associated with the user to the platform user account associated with the user based on the data descriptive of the first application user account and the data descriptive of the platform user account. The operations include determining, for a software license associated with the second application user account, a use status of the software license based on data associated with the second application user account. The operations include associating the use status of the software license with the at least one platform user account matched with the second application user account. The operations include providing a user interface for display, the user interface indicating the use status of the software license in association with the platform user account.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example environment including a computing system that performs operations, according to example embodiments of the present disclosure.

FIG. 2 depicts a block diagram of an example of a computing device, according to example embodiments of the present disclosure.

FIG. 3 depicts a block diagram of an example computing environment including multiple computing systems, according to example embodiments of the present disclosure.

FIG. 4 depicts a flow diagram of an example method for managing a plurality of software licenses, according to example embodiments of the present disclosure.

FIG. 5 depicts a flow diagram of an example method for matching user accounts based on information associated with the user accounts, according to example embodiments of the present disclosure.

FIG. 6 illustrates an example user interface, according to example embodiments of the present disclosure.

Reference numerals that are repeated across plural figures are intended to identify the same features in various implementations.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally, the present disclosure is directed to managing software licenses for an organizational entity, such as a business. In particular, examples described in the present disclosure enable the organizational entity to efficiently identify software licenses and subscriptions that are in use, are inactive, are not being used, and/or are associated with users no longer employed by the organizational entity. Examples described in the present disclosure also enable the organization to efficiently (e.g., automatically) manage the identified software licenses and subscriptions, such as canceling licenses and subscriptions for accounts no longer active or in use, identifying users not actively using licenses and subscriptions and modifying or removing the license or subscription, determining overall utilization of licenses and subscriptions across the organizational entity, and the like. This saves employees of the organization time and effort in making management decisions for software licenses and also provides for more efficient use of computational resources such as memory usage.

To manage software licenses, examples described in the present disclosure can be implemented by and/or otherwise leverage an organizational management platform. The organizational management platform holds, for each of one or more organizations, a centralized set of organizational data that acts as a single, centralized system of record for all organizational management processes for that organization. Each organization can include a number of users which are able to access and interact with the organizational management platform. Some users may have administrative permissions which define whether the user is able to access and/or modify certain types of organizational data for their organization.

The organizational data for each organization can include data directly entered into the organizational management platform and/or can include data retrieved, pulled, or otherwise obtained from one or more first party and/or third-party applications with which the organizational management platform may have varying levels of integration. This ingestion and storage of data from third-party applications is in contrast to systems which simply sit on top of third-party applications and apply rules at run time.

In some implementations, the organizational management platform can provide a user with the ability to configure the cadence or periodicity at which the organizational management platform receives or ingests data (e.g., via .csv files) from third-party applications. Data can be transferred between the organizational management platform and third-party applications (e.g., to and/or from) using various techniques such as application programming interfaces, data hooks, flat files, bulk uploads/downloads and/or other data transfer mechanisms.

The organizational data is, in some implementations, held as one or more object databases. For example, multiple object classes can be defined in the object databases. Example object classes include employees, devices, job candidates, benefits policies, documents, pay instances, time cards, and/or other objects. For each object, values can be provided and maintained for one or more attributes, such as location, role, salary, etc. Links can be made between different objects. For example, one or more device objects can be associated with employee objects.

The object database(s) can be represented as or can store data which can be represented as one or more graphs with nodes that correspond to objects and edges that correspond to links or logical associations between objects and/or object attribute(s). Graph(s) can be traversed to understand or leverage relationships among objects and their attribute(s). In one example, the organizational data can be synthesized into a single graph which includes multiple classes of objects and defines complex relationships among objects and their attribute(s). For example, all workflows, including payroll, IT, etc. can be run through one platform and graph. In some implementations, the employee objects can be referred to and/or treated as sentinel nodes (e.g., first-defined nodes around which other nodes/relationships can be established).

In some implementations, the organizational data can include organizational structure data. For example, the organizational structure data can be encoded within links or edges defined between objects of the organizational data or can be stored as a separate data layer. For example, the organizational structure data can define organizational relationships between objects, including employee objects. As one example, the organizational structure data may indicate that a first employee object has the relationship of “manager” relative to a second employee object. The organizational relationships can be defined between specific objects and/or groups of objects. As another example, the organizational structure data may indicate that a first group of employees (e.g., the “IT Administrator” group of employees) has a certain set of permissions (e.g., device activation/deactivation) relative to a particular group of devices (e.g. the “work laptops” group of the devices).

In some implementations, aspects of the present disclosure (e.g., automated workflows or other processing routines) can be implemented using a domain-specific query language that can be used to perform (e.g., in real time) queries against the organizational data. The query language can be used to define functions or queries which return data that satisfies or responds to the functions or queries. In some implementations, the query language is a declarative language. In some implementations, the query language includes organization functions or operators which leverage organizational relationships within the organizational data. For example, the organization function ORG(employee,relationship) returns one or more other employees that have the specified relationship to the specified employee.

Examples systems and methods described in the present disclosure can include one or more computing systems that can access the data from the organizational management platform, such as user profile data, and data from any of the third-party software applications, such as data related to user accounts and associated software licenses for the third-party software applications. The one or more computing systems can then match user accounts across the organizational management platform and the third-party software applications to associate user accounts on the organizational management platform with software licenses. For example, one or more pre-defined rules can be evaluated to build confidence towards a potential match. The one or more computing systems can then generate statistics related to the usage of software licenses by users of the organizational management platform, such as an amount of licenses in use, an amount of expired licenses, an amount of inactive licenses, and other similar statistics related to license usage. These statistics can then be compiled into a user interface for display to a manager of software licenses, such as an IT administrator or similar employee within the organization. Alternatively or additionally, various automated operations can be performed to modify the status of various software licenses (e.g., automatic cancellation of un-used licenses).

The systems, methods, and computer program products described herein provide a number of technical effects and benefits. As one example, the embodiments described in the present disclosure perform software license management that utilize different underlying technologies and technical designs more efficiently and with fewer computing resources (e.g., less processing power, less memory usage, less power consumption, etc.), that would otherwise be wasted by maintaining custom, proprietary, and/or manual processes. In particular, examples of the present disclosure allow for quick and efficient identification of software licenses and subscriptions that are no longer being used or are underused by organizations, such as businesses. As another example, by canceling or removing un- or under-utilized application user accounts, storage space that has been dedicated to or otherwise associated with the removed application user account can be deleted or otherwise freed-up. This results in a reduction in the overall use of memory, thereby reducing consumption of computational resources.

Examples of the present disclosure also allow for automatic identification of matching profiles between various software applications and the platform and associated automatic management of software licenses for those software applications. Due to the automatic identification and matching, network bandwidth, processing bandwidth, and memory storage space can be saved, as these actions save the amount of time needed to compile this information, saving up-time for computing systems, memory used to compile the information, network bandwidth communicating to and from various information sources, and the like.

With reference to the Figures, example embodiments of the present disclosure will be discussed in further detail.

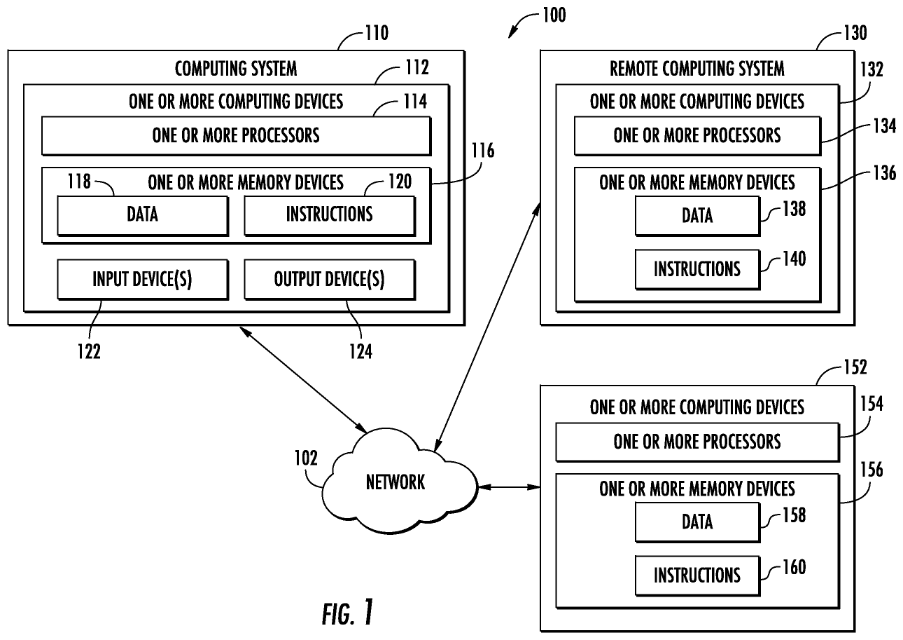

FIG. 1 depicts a block diagram of an example environment 100 including a computing system 110 that performs operations according to example embodiments of the present disclosure. The environment 100 includes a network 102, a computing system 110, one or more computing devices 112, one or more processors 114, one or more memory devices 116, data 118, instructions 120, a remote computing system 130, one or more computing devices 132, one or more processors 134, one or more memory devices 136, data 138, instructions 140, one or more computing devices 152, one or more processors 154, one or more memory devices 156, data 158, and instructions 160.

The network 102 can include any type of communications network. For example, the network 102 can include a local area network (LAN), a wide area network (WAN), an intranet, an extranet, and/or the internet. Further, the network 102 can include any number of wired or wireless connections and/or links that can be used to communicate with one or more computing systems (e.g., the computing system 110 and/or the remote computing system 130) and/or one or more devices (e.g., the one or more computing devices 152). Communication over the network 102 can be performed via any type of wired and/or wireless connection and can use a wide variety of communication protocols (e.g., TCP/IP, HTTP, SMTP, FTP), encodings or formats (e.g., HTML, XML), and/or protection schemes (e.g., VPN, secure HTTP, SSL).

The computing system 110 can include any combination of systems and/or devices including one or more computing systems (not shown) and/or one or more computing devices 112. Further, the computing system 110 may be connected (e.g., networked) to one or more computing systems (e.g., remote computing system 130) and/or one or more computing devices (e.g., one or more computing devices 132, 152) via the network 102. The computing system 110 may operate in various different configurations including as a server or a client machine in a client-server network environment, or as a peer machine in a peer-to-peer (or distributed) network environment. Though the computing system 110 is depicted in FIG. 1 as a single device, the computing system 110 can include any collection or combination of devices that individually or in combination with other devices, execute a set of one or more instructions to perform any one or more of the operations discussed herein.

In this example, the computing system 110 includes the one or more computing devices 112. The one or more computing devices 112 can include any type of computing device. For example, the one or more computing devices 112 can include a personal computing device (e.g., a desktop computing device), a mobile computing device (e.g., a smartphone or tablet device), a wearable computing device (e.g., a smartwatch device), an embedded computing device, a web appliance, a server computing device, a network router, a switch, a bridge, or any device capable of executing a set of instructions (e.g., any combination of instructions which can include sequential instructions and/or parallel instructions) associated with one or more operations and/or one or more actions to be performed by the computing system 110 or any of the constituent components and/or devices of the computing system 110.

Any of the one or more computing devices 112 can include the one or more processors 114. The one or more processors 114 can include any processing device (e.g., a processor core, a microprocessor, an ASIC, a FPGA, a controller, or a microcontroller) and can include one processor or multiple processors that may be operatively connected. In some embodiments, the one or more processors 114 may include one or more complex instruction set computing (CISC) microprocessors, one or more reduced instruction set computing (RISC) microprocessors, one or more very long instruction word (VLIW) microprocessors, and/or one or more processors that are configured to implement other instruction sets.

The one or more computing devices 112 can include the one or more memory devices 116. The one or more memory devices 116 can be used to store data and/or information and can include one or more computer-readable media, one or more non-transitory computer-readable storage media, and/or one or more machine-readable media. Though the one or more memory devices 116 are depicted in FIG. 1 as a single unit (e.g., a single medium), the computer-readable storage media can include a single medium or multiple media (e.g., a centralized or distributed database, and/or associated caches and servers) that store one or more sets of instructions. Further, the computer-readable storage media can include any medium that is capable of storing, encoding, and/or carrying a set of instructions for execution by a computing device and which may cause the computing device to perform any of the one or more operations described herein. In some embodiments, the computer-readable storage media can include one or more solid-state memories, one or more optical media, and/or one or more magnetic media. By way of example, the one or more memory devices 116 can include any combination of random-access memory (RAM), read-only memory (ROM), EEPROM, EPROM, one or more flash memory devices, and/or one or more magnetic storage devices (e.g., one or more hard disk drives).

The one or more processors 114 can be configured to execute one or more instructions to perform the operations described herein including, for example, one or more operations associated with managing software licenses for third-party software applications. Further, the one or more memory devices 116 can store the data 118 and/or the instructions 120, which can be executed by the one or more processors 114 to cause the one or more computing devices 112 to perform one or more operations. For example, the one or more operations performed by the one or more processors 114 can include receiving or obtaining user account data, matching user account data across an organizational management platform and one or more third-party software applications, determining software license or subscription use data for each user or third-party software application, and managing software licenses and subscriptions for the organization.

The data 118 can include organizational data (e.g., organizational data that can include one or more organizational records), one or more data structures defining, describing, and/or otherwise associated with the organizational data, rule data (e.g., rule data that includes one or more rules used to configure an application policy, one or more rules maintained by or otherwise associated with an organizational data management system, one or more rules for matching third-party etc.), application data (e.g., application data associated with a plurality of applications including one or more third-party applications and/or one or more intra-organizational applications), third-party integration data (e.g., data providing configuration and/or other information for performing integration and synchronization with each of one or more different third-party systems and/or applications), organizational policy data (e.g., organizational policy data associated with one or more organizational policies), application policy data (e.g., policy data that includes one or policies associated with the organizational data, the rule data, the application data, one or more applications, one or more devices, etc.), and/or other types of data. Further, the instructions 120 can include one or more instructions to use data including the data 118 to perform any one or more of the various operations described herein. In some embodiments, the one or more memory devices 116 can be used to store one or more applications that can be operated by the one or more processors 114. The data 118, the instructions 120, and/or the one or more applications can be associated with an organization. Further, the computing system 110 may be associated with an organization and may be configured to manage the one or more applications. For example, the computing system 110 can perform one or more operations associated with authenticating one or more users that attempt to access the one or more applications which can include one or more third-party applications, which may be remote from the computing system 110.

Any of the one or more computing devices 112 can include one or more input devices 122 and/or one or more output devices 124. The one or more input devices 122 can be configured to receive input (e.g., user input) and can include one or more touch screens, one or more keyboards, one or more pointing devices, (e.g., mouse device), one or more buttons, one or more microphones, and/or one or more cameras. The one or more output devices 124 can include one or more display devices, one or more loudspeaker devices, one or more haptic output devices. By way of example, the one or more output devices 124 can be used to display a graphical user interface via a display device that can include a touch screen layer that is configured to detect one or more inputs (e.g., one or more user inputs). The one or more processors 114 may perform one or more operations (e.g., operations associated with providing application integration and synchronization) based at least in part on the one or more inputs.

The remote computing system 130 includes the one or more computing devices 132. Each of the one or more computing devices 132 can include one or more processors 134, one or more memory devices 136, the data 138, and/or the instructions 140. The remote computing system 130 can include any of the attributes and/or capabilities of the computing system 110. Further, the remote computing system 130 can communicate with one or more devices and/or one or more systems via the network 102.

In some embodiments, the remote computing system 130 can include one or more applications (e.g., computer software applications) that can be stored and/or executed by the remote computing system 130. Further, the one or more applications can include one or more third-party applications that may be accessed from the computing system 110 and which are at least partly operated from the remote computing system 130. The one or more third-party applications generally may be associated with and provided by an organization that is different from the organization that is associated with the computing system 110. Further, the data 138 can include one or more portions of the organizational data (e.g., one or more organizational records), one or more data structures associated with the organizational data, rule data, organizational policy data, application policy data, third-party integration data, and/or other types of data.

One or more computing devices 152 (e.g., user devices or any other types of devices) can include one or more processors 154, one or more memory devices 156, the data 158, and/or the instructions 160. Such one or more computing devices 152 may include any of the attributes and/or capabilities of the one or more computing devices 112, 132. Further, such one or more computing devices 152 can communicate with one or more devices and/or one or more systems via the network 102.

In some embodiments, the one or more computing devices 152 can include one or more applications (e.g., computer software applications) that can be stored and/or executed by such one or more computing devices 152. Further, the one or more applications can include one or more third-party applications that may be accessed from the one or more computing devices 152 and which are at least partly operated from such one or more computing devices 152. Data 138 may include, for example, one or more portions of the organizational data (e.g., one or more organizational records), one or more data structures associated with the organizational data, rule data, organizational policy data, application policy data, third-party integration data (e.g., third-party application integration data), and/or other types of data.

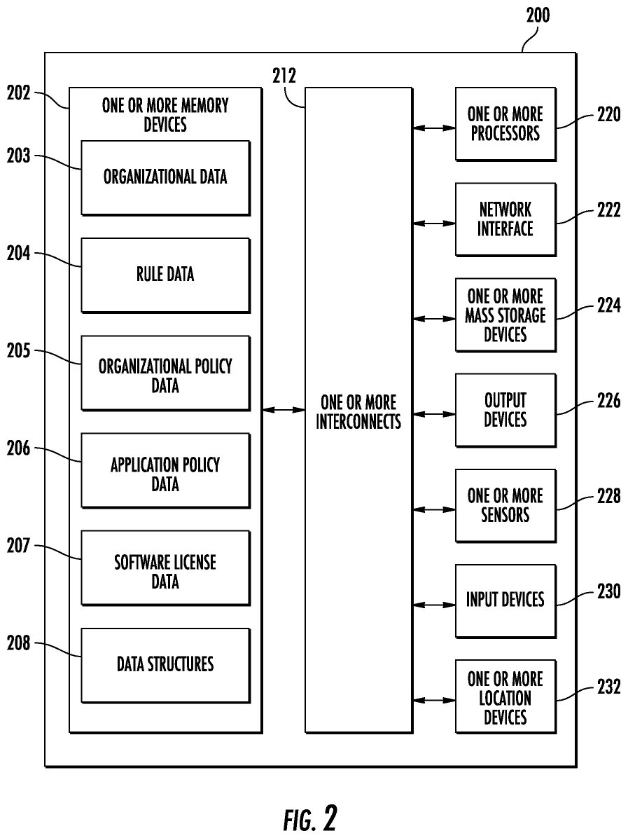

FIG. 2 depicts a block diagram of an example computing device 200 according to example embodiments of the present disclosure. The computing device 200 can include one or more attributes and/or capabilities of the computing system 110, the remote computing system 130, the one or more computing devices 152, and/or the computing device 200. Furthermore, the computing device 200 can be configured to perform one or more operations and/or one or more actions that can be performed by the computing system 110, the remote computing system 130, the one or more computing devices 152, and/or the computing device 200.

As shown in FIG. 2, the computing device 200 can include one or more memory devices 202, organizational data 203, rule data 204, organizational policy data 205, application policy data 206, integration data 207, data structures 208, one or more interconnects 212, one or more processors 220, a network interface 222, one or more mass storage devices 224, one or more output devices 226, one or more sensors 228, one or more input devices 230, and/or one or more location devices 232.

The one or more memory devices 202 can store information and/or data (e.g., organizational data 203, rule data 204, organizational policy data 205, application policy data 206, integration data 207, data structures 208, and/or any other data). Further, the one or more memory devices 202 can include one or more non-transitory computer-readable storage media, including RAM, ROM, EEPROM, EPROM, flash memory devices, magnetic disks, and any combination thereof. The information and/or data stored by the one or more memory devices 202 can be executed by the one or more processors 220 to cause the computing device 200 to perform one or more operations associated with managing software licenses and subscriptions across an organizational entity, including analyzing and displaying license and subscription usage data on a per-user or per-third-party software application basis, enact changes to software licensing and subscription use statuses (e.g., cancel licenses for certain users), identify users associated with software licenses and subscriptions based on user data, and other operations.

The organizational data 203 can include one or more portions of data (e.g., the data 118, the data 138, and/or the data 158, which are depicted in FIG. 1) and/or instructions (e.g., the instructions 120, the instructions 140, and/or the instructions 160, which are depicted in FIG. 1) that are stored respectively in any of the one or more memory devices 116, 136, 156. The organizational data 203 also can include information associated with one or more applications (e.g., one or more third-party applications), one or more organizational records and/or one or more organizational policies. In some embodiments, the organizational data 203 can be received from one or more computing systems (e.g., the remote computing system 130 depicted in FIG. 1) which can include one or more computing systems that are remote (e.g., in another room, building, part of town, city, or nation) from the computing device 200.

The rule data 204 can include one or more portions of data (e.g., the data 118, the data 138, and/or the data 158, which are depicted in FIG. 1) and/or instructions (e.g., the instructions 120, the instructions 140, and/or the instructions 160 which are depicted in FIG. 1) that are stored in the one or more memory devices 116, the one or more memory devices 136, and/or the one or more memory devices 156, respectively. The rule data 204 can include information associated with one or more rules that can be used to access third-party software applications and application user account data, access platform account data, perform account matching by comparing platform account data and application user account data, generate confidence scores for matching user profiles, generate weights for particular confidence scores or other rules, identify user accounts on third-party software applications based on platform user account data and/or application user account information associated with other third-party software applications, and the like. In some embodiments, the rule data 204 can be received from one or more computing systems (e.g., the remote computing system 130 depicted in FIG. 1), which can include one or more computing systems that are remote from the computing device 200.

The organizational policy data 205 can include one or more portions of data (e.g., the data 118, the data 138, and/or the data 158, which are depicted in FIG. 1) and/or instructions (e.g., the instructions 120, the instructions 140, and/or the instructions 160 which are depicted in FIG. 1) that are stored in the one or more memory devices 116, the one or more memory devices 136, and/or the one or more memory devices 156, respectively. Furthermore, the organizational policy data 205 can include information associated with one or more organizational policies that are used to regulate one or more applications (e.g., one or more third-party applications), one or more computing devices, and/or one or more records which can include one or more organizational records and/or one or more employee records. In some embodiments, the organizational policy data 205 can be received from one or more computing systems (e.g., the remote computing system 130 depicted in FIG. 1) which can include one or more computing systems that are remote from the computing device 200.

The application policy data 206 can include one or more portions of data (e.g., the data 118, the data 138, and/or the data 158, which are depicted in FIG. 1) and/or instructions (e.g., the instructions 120, the instructions 140, and/or the instructions 160 which are depicted in FIG. 1) that are stored in the one or more memory devices 116, the one or more memory devices 136, and/or the one or more memory devices 156, respectively. Furthermore, the application policy data 206 can include information associated with one or more policies that are used to implement an application policy associated with one or more applications (e.g., one or more third-party applications), one or more computing devices, and/or one or more records which can include one or more organizational records and/or one or more employee records. In some embodiments, the application policy data 206 can be received from one or more computing systems (e.g., the remote computing system 130 depicted in FIG. 1) which can include one or more computing systems that are remote from the computing device 200.

The software license data 207 can include one or more portions of data (e.g., the data 118, the data 138, and/or the data 158, which are depicted in FIG. 1) and/or instructions (e.g., the instructions 120, the instructions 140, and/or the instructions 160 which are depicted in FIG. 1) that are stored in the one or more memory devices 116, the one or more memory devices 136, and/or the one or more memory devices 156, respectively. The software license data 207 can include information associated with various software licenses and subscriptions associated with an organization. For example, software license data 207 can include data indicating a number of software licenses or subscriptions owned by an organization, a number of licenses or subscriptions in use by users associated with the organization, associations between specific users and licenses or subscriptions, usage data regarding each license or subscription, and the like. In some embodiments, the software license data 207 can be received from one or more computing systems (e.g., the remote computing system 130 depicted in FIG. 1), which can include one or more computing systems that are remote from the computing device 200.

The data structures 208 can include one or more portions of data (e.g., the data 118, the data 138, and/or the data 158, which are depicted in FIG. 1) and/or instructions (e.g., the instructions 120, the instructions 140, and/or the instructions 160 which are depicted in FIG. 1) that are stored in the one or more memory devices 116, the one or more memory devices 136, and/or the one or more memory devices 156, respectively. The data structures 208 can include one or more logical and/or physical instances of information representing or describing one or more entities (e.g., objects, records, etc.), one or more relationships involving one or more of the entities, one or more data values associated with each of one or more of the entities and/or one or more of the relationships, one or more functions and/or operations that may be applied to each of one or more of the entities and/or one or more of the relationships, any other data or metadata describing or otherwise defining structure and/or rules associated with one or more of the entities and/or one or more of the relationships, etc.

The data structures 208 can be implemented and utilized with one or more types of computer software, computer hardware, or any combination thereof. In an embodiment, the data structures 208 are used to represent and perform processing associated with various types of organizational data. For example, the data structures 208 may include information about various types of information and entities associated with organizational data including, but not limited to, individuals (e.g., employees, vendors, independent contractors), departments, teams, groups, locations, offices, documents, tasks, reports, accounts, devices, applications, end-user applications, licenses, workflows, alerts, and/or any other types of entities representing or related to managing organizational data. The data structures 208 also can define various relationships among the various entities associated with organizational data. For example, the data structures 208 may define and be used to enforce relationships such as each employee must be assigned to a department, each employee can be included on one or more teams, each employee must be assigned to a primary location, each employee may be assigned to one or more secondary locations, employees may have one or more computing devices, each vendor must have a current audit, each independent contractor must be associated with a contract, and/or any other relationships provided by an organizational data management system or configured for an organization that utilizes an organizational data management system (e.g., a system for managing organizational data based on one or more organizational data management applications).

In some embodiments, the data structures 208 can include one or more object graphs providing information about entities, relationships, and/or any other aspects relating to the definition, structure, and rules associated with organizational data. The data structures 208 also can include any one or more other types of data structures (e.g., with or without the use of object graphs) that provide information about entities, relationships, and/or any other aspects of the definition, structure, and rules associated with organizational data. In some embodiments, the data structures 208 can be received from one or more computing systems (e.g., the remote computing system 130 depicted in FIG. 1), which can include one or more computing systems that are remote from the computing device 200.

The one or more interconnects 212 can include one or more interconnects or buses that can be used to send and/or receive one or more signals (e.g., electronic signals) and/or data (e.g., organizational data 203, rule data 204, organizational policy data 205, application policy data 206, integration data 207, data structures 208, and/or any other data) between components of the computing device 200, including the one or more memory devices 202, the one or more processors 220, the network interface 222, the one or more mass storage devices 224, the one or more output devices 226, the one or more sensors 228 (e.g., a sensor array), the one or more input devices 230, and/or the one or more location devices 232. The one or more interconnects 212 can be arranged or configured in different ways. For example, the one or more interconnects 212 can be configured as parallel or serial connections. Further the one or more interconnects 212 can include one or more internal buses that are used to connect the internal components of the computing device 200 and one or more external buses used to connect the internal components of the computing device 200 to one or more external devices. By way of example, the one or more interconnects 212 can include different interfaces including Industry Standard Architecture (ISA), Extended ISA, Peripheral Components Interconnect (PCI), PCI Express, Serial AT Attachment (SATA), HyperTransport (HT), USB (Universal Serial Bus), Thunderbolt, IEEE 1394 interface (FireWire), and/or other interfaces that can be used to connect components.

The one or more processors 220 can include one or more computer processors that are configured to execute the one or more instructions stored in the one or more memory devices 202. For example, the one or more processors 220 can, for example, include one or more general purpose central processing units (CPUs), application specific integrated circuits (ASICs), and/or one or more graphics processing units (GPUs). Further, the one or more processors 220 can perform one or more actions and/or operations including one or more actions and/or operations associated with the organizational data 203, the rule data 204, the organizational policy data 205, the application policy data 206, the integration data 207, the data structures 208, and/or any other data. The one or more processors 220 can include single or multiple core devices including a microprocessor, microcontroller, integrated circuit, and/or a logic device.

The network interface 222 can support network communications. The network interface 222 can support communication via networks including a local area network and/or a wide area network (e.g., the internet). For example, the network interface 222 can allow the computing device 200 to communicate with the computing system 110 via the network 102.

The one or more mass storage devices 224 (e.g., a hard disk drive and/or a solid-state drive) can be used to store data including the organizational data 203, the rule data 204, the organizational policy data 205, the application policy data 206, the integration data 207, the data structures 208, and/or any other data. The one or more output devices 226 can include one or more display devices (e.g., liquid crystal display (LCD), OLED display, mini-LED display, micro-LED display, plasma display, and/or cathode ray tube (CRT) display), one or more light sources (e.g., LEDs), one or more loudspeakers, and/or one or more haptic output devices (e.g., one or more devices that are configured to generate vibratory output).

The one or more sensors 228 can be configured to detect various states and can include one or more cameras, one or more light detection and ranging (LiDAR) devices, one or more sonar devices, and/or one or more radar devices. Further, the one or more sensors 228 can be used to provide input (e.g., an image of a user captured using the one or more cameras) that can be used as part of invoking or performing one or more operations. For example, the one or more sensors 228 can be used to authenticate the identity of a user and determine an authorization level based on an image of the user's face that is captured using the one or more sensors 228.

The one or more input devices 230 can include one or more touch sensitive devices (e.g., a touch screen display), a mouse, a stylus, one or more keyboards, one or more buttons (e.g., ON/OFF buttons and/or YES/NO buttons), one or more microphones, and/or one or more cameras (e.g., cameras that are used to detect gestures that can trigger one or more operations by the computing device 200).

Although the one or more memory devices 202 and the one or more mass storage devices 224 are depicted separately in FIG. 2, the one or more memory devices 202 and the one or more mass storage devices 224 can be regions within the same memory module. The computing device 200 can include one or more additional processors, memory devices, and/or network interfaces, which may be provided separately or on the same chip or board. The one or more memory devices 202 and the one or more mass storage devices 224 can include one or more computer-readable media, including, but not limited to, non-transitory computer-readable media, RAM, ROM, hard drives, flash drives, and/or other memory devices.

The one or more memory devices 202 can store sets of instructions for applications including an operating system that can be associated with various software applications or data. For example, the one or more memory devices 202 can store sets of instructions for one or more applications (e.g., one or more organizational applications and/or one or more third-party applications) that are subject to one or more application policies or utilize third-party integration data that can be configured, generated, and/or implemented by the computing device 200 and/or one or more other computing devices or one or more computing systems. In some embodiments, the one or more memory devices 202 can be used to operate or execute a general-purpose operating system that operates on mobile computing devices and/or and stationary devices, including for example, smartphones, laptop computing devices, tablet computing devices, and/or desktop computers.

The software applications that can be operated or executed by the computing device 200 can include applications associated with the computing system 110, the remote computing system 130, and/or the one or more computing devices 152 that are depicted in FIG. 1. Further, the software applications that can be operated and/or executed by the computing device 200 can include native applications, web services, and/or web-based applications.

The one or more location devices 232 can include one or more devices or circuitry for determining the position of the computing device 200. For example, the one or more location devices 232 can determine an actual and/or relative position of the computing device 200 by using a satellite navigation positioning system (e.g. a GPS system, a Galileo positioning system, the GLObal Navigation satellite system (GLONASS), the BeiDou Satellite Navigation and Positioning system, an inertial navigation system, a dead reckoning system, based on IP address, by using triangulation and/or proximity to cellular towers or Wi-Fi hotspots, and/or beacons.

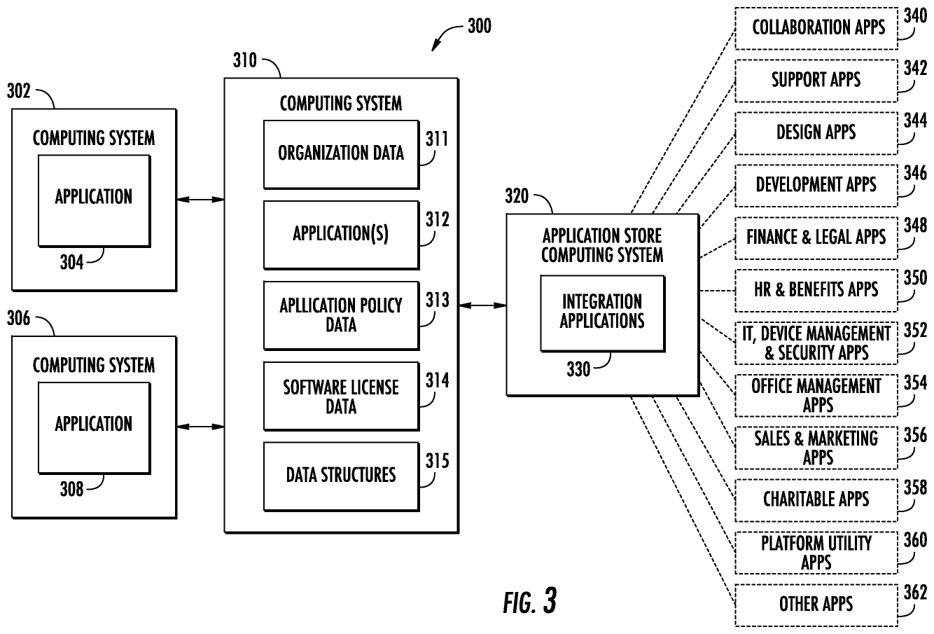

FIG. 3 depicts a block diagram of an example computing environment 300 including multiple computing systems, according to example embodiments of the present disclosure. Any of computing system 302, computing system 306, or computing system 310 can include one or more attributes and/or capabilities of the computing system 110, the remote computing system 130, the one or more computing devices 152, and/or the computing device 200. Furthermore, any of the computing system 302, the computing system 306, or the computing system 310 can be configured to perform one or more operations and/or one or more actions that can be performed by the computing system 110, the remote computing system 130, the one or more computing devices 152, and/or the computing device 200.

As shown in FIG. 3, the environment 300 includes the computing system 302, an application 304, the computing system 306, an application 308, the computing system 310, organizational data 311, one or more application(s) 312, application policy data 313, software license data 314, data structures 315, application store computing system 320, integration applications 330, collaboration apps 340, support apps 342, design apps 344, development apps 346, finance and legal apps 348, human resources (FIR) and benefits apps 350, information technology (IT), device management, and security apps 352, office management apps 354, sales and marketing apps 356, charitable apps 358, platform utility apps 360, and other apps 362.

In an embodiment, the computing system 302, the computing system 306, the computing system 310, and/or the application store computing system 320 can be configured to communicate directly and/or via a communication network (e.g., the network 102 depicted in FIG. 1). In one embodiment, the computing system 302 includes an application 304 that is stored and/or operates on the computing system 302 and can communicate (e.g., send and/or receive data and/or information) with one or more other computing systems including the computing system 306 and/or the computing system 310. The application 304 can, for example, include an email application that performs one or more operations on the computing system 302 and includes an email account associated with an organizational record (e.g., an employee record including the name of an employee, an email access identifier, and an email passcode) that is stored as part of the organizational data 311. In an example, a user associated with any computing system 302, 306, 310 can use a portion of the organizational data 311 associated with their employee record to access a corresponding account associated with one or more of application 304, application 308, and/or application(s) 312.

In an embodiment, the computing system 310 includes one or more application(s) 312 that can perform one or more operations on the computing system 310 and can communicate data and/or information with any one or more computing systems, including the computing system 302 and/or the computing system 306, or any one or more computing devices. The application(s) 312 can, for example, include an employee management application that operates on the computing system 310 and accesses the organizational data 311, which can include one or more organizational records associated with the names of organization employees and the respective employment statuses for each of the employees (e.g., an employee's position or role within the organization, an organizational department associated with the employee, etc.). A user (e.g., a privileged user, such as a manager or administrator with the authority to access and/or modify the organizational data 311) associated with the computing system 306 can, for example, access and/or modify the organizational data 311 to reflect when an employee receives a promotion or a raise, changes to a different department, is added to one or more new teams, etc.

The one or more application(s) 312 can perform one or more operations on the computing system 310 and can communicate data and/or information with one or more computing systems, including the computing system 302 and/or the computing system 306, or any one or more computing devices. The application(s) 312 can, for example, include an administrative or other type of system application to manage one or more aspects of the application(s) 312 including, but not limited to, installing, configuring, maintaining, updating, integrating, automating and/or performing one or more other operations associated with the application(s) 312 on the computing system 310 and that can manage one or more aspects of one or more other applications on different systems and devices, which may include the application 304 and/or the application 308.

In some embodiments, the application(s) 312 can include one or more third-party applications that are stored and/or perform operations on the computing system 310. Further, the application(s) 312 can retrieve data and/or information associated with and/or operate in cooperation with applications external to the computing system 310 (e.g., the computing system 302 and/or the computing system 306). The application(s) 312 can also use (e.g., access, modify, and/or control) the organizational data 311. For example, the application(s) 312 can use the organizational data 311 that is associated with the application 304 to perform one or more operations using the application 308 that is on the computing system 306.

The computing system 310 includes the application policy data 313 which can be implemented on the computing system 310 and can be used to perform one or more operations associated with implementing an application policy associated with the organizational data 311 and/or one or more applications including the application 304, the application 308, and/or application(s) 312. The application 304, the application 308, and/or application(s) 312 can include one or more third-party applications that are separate from, that are operated separate and apart from, and that are not affiliated with the organization that manages, owns, controls and/or maintains the organizational data 311 or an associated organizational data management application on the computing system 310, and/or that determines or implements an application policy associated with the application policy data 313. In one example, third-party applications can be differentiated from organizational applications that, for example, are inherent to, are a part of, or otherwise operate directly or as part of an organizational data management application, system, services, or platform.

The application policy data 313 can include one or more rules that determine how one or more applications including, for example, one or more third-party applications or organizational applications are accessed, modified, and/or controlled. For example, the application policy data 313 can use the organizational data 311 that is associated with the application(s) 304 to perform one or more operations on the application(s) 312 and/or the application 308. Also, the application policy data 313 can use the organizational data 311 that is associated with the application(s) 312 to perform one or more operations on the application 304 and/or the application 308. By way of further example, the application policy data 313 can use the organizational data 311 that is associated with the application 308 to perform one or more operations on the application 304 and/or the application(s) 312. In some embodiments, the application policy data 313 can determine how a combination of one or more organizational applications (e.g., applications owned and controlled by an organization that owns and controls the organizational data 311 and/or applications provided with or as part of an organizational data management system used by the organization as the system of record for maintaining the organizational data 311, etc.) and/or one or more third-party applications are accessed, modified, configured, and/or controlled.

The computing system 310 includes the software license data 314, which can reside on the computing system 310 and can be used, for example, to perform one or more operations that integrate the organizational data 311 and associated activities based on the organizational data 311 across one or more different computing systems (e.g., such as computing systems 302, 306, and 310) and/or applications (e.g., such as applications 304, 308, and 312). For example, the software license data 314 can be used to integrate and synchronize organizational data 311 and/or associated operations across an organizational data management application or system (e.g., a system of record for organization data 311) and each of one or more separate third-party applications that utilize organizational data 311 and/or perform operations based on organizational data 311.

In an embodiment, the software license data 314 can include data indicating a number of software licenses or subscriptions owned by an organization, a number of licenses or subscriptions in use by users associated with the organization, associations between specific users and licenses or subscriptions, usage data regarding each license or subscription, and the like. Software license data 314 can also include one or more instructions that, when executed by computing system 310, allow the computing system 310 to perform operations related to management of software licenses and subscriptions. For example, the instructions can include enabling or disabling a software license or subscription for a user, suspending access to a software license or subscription for a user, gathering usage data regarding software licenses or subscriptions, and the like.

The computing system 310 includes the data structures 315, which can be implemented on the computing system 310 and used to perform operations involving the organizational data 311 including, but not limited to, performing integration and synchronization of the organizational data 311 with one or more different third-party applications and/or systems. In an embodiment, the data structures 315 generally can include information about the properties or attributes of each of one or more entities associated with the organizational data 311. Data structures 315 also can include information describing relationships associated with one or more entities associated with the organizational data 311. In some embodiments, the data structures 315 generally can be used in validating and processing the organizational data 311 and/or other information received from third-party applications and/or systems. The data structures 315 also can be used in association with performing or otherwise carrying out one or more operations involving the organizational data 311 including, but not limited to, processing requests, validating queries, generating workflows, executing workflows, creating reports, running reports, etc.

In an embodiment, the data structures 315 can include one or more object graphs that provide information about entities, relationships, rules, constraints, and/or any other aspects of managing the organizational data 311. For example, such object graphs can include one or more nodes representing entities associated with the organizational data 311 and one or more edges that connect and represent relationships between the nodes. The data structures 315 can also include organizational data and/or associated metadata. In addition, the data structures 315, together or alone, generally may represent one or more aspects of an application or system (e.g., such as an organizational data management system that is a system of record for organizational data 311 of an organization).

In an embodiment, the application store computing system 320 provides an organization with access to multiple different integration applications 330 for integrating organizational data 311 and/or associated processes with and across various different applications and/or systems (e.g., such as third-party applications and/or systems). Application store computing system 320 also may provide an organization with one or more other types of applications, including but not limited to, platform utility apps 360 that provide additional functionality to an organizational data management application or system, other apps 362 that may include integration-related applications, and/or any other types of applications. Generally, the application store computing system 320 may provide one or more various applications for a flat fee, based on a subscription purchase, for a fee based on usage, for a fee based on a number of users, computing systems, processors, or any other criteria, as part of a limited trial, for free, and/or generally under any type of arrangement. In an embodiment the application store computing system 320 is managed and provided by the same party that provides an organizational data management system to organizations. For example, the integration applications 330 provided by the application store computing system 320 generally may be specialized for use with the organizational data management system (e.g., and not end-user versions of applications that would be installed for general purpose use by end-users on end-user devices).

In an embodiment, the integration applications 330 generally can be any application that allows an organization to manage any one or more aspects associated with providing one or more corresponding end-user applications to individual members, teams, roles, departments, and/or any other grouping or categorization of individuals in an organization. For example, each of the integration applications 330 can be used by an organization to control and automate various tasks associated with provisioning, configuring, maintaining, and integrating third-party applications. In some embodiments, one or more of the integration applications 330 can allow an organization to configure automated assignment of a corresponding end-user application to one or more individuals, user account creation, single sign-on setup, provisioning, installation, setup, and/or maintenance of corresponding end-user applications (e.g., third-party applications or other applications provided for use by end users) provided to particular individuals, groups, and/or one or more devices associated with such individuals or groups in the organization.

In an embodiment, one or more of the integration applications 330 can provide integration of organizational data 311 and associated services across third-party applications or computing systems and one or more applications or computing systems of an organization associated with organizational data 311. For example, each of the integration applications 330 can provide one or more of user account creation, single sign-on integration, user account suspension or removal, user management, group management, user privileges, user data access, user data control, template management, data integration, process automation, and/or any other types of integration between applications (e.g., third-party applications or other applications) that are associated with organizational data 311 of an organization.

In an embodiment, one or more of the integration applications 330 can access software license data 314 to allow computing system 310 to access various third-party software applications. For example, when a user of the computing system 310 attempts to access a third-party software application, one or more of the integration applications 330 checks software license data 314 to determine if the user has a software license to access the third-party application. The one or more of the integration applications 330 can then allow or deny access to third-party software applications based on a use status of the software license.

In an embodiment, the integration applications 330 and/or other applications provided by the application store computing system 320 may include, but are not limited to, collaboration apps 340, support apps 342, design apps 344, development apps 346, finance and legal apps 348, human resources (HR) and benefits apps 350, information technology (IT), device management, and security apps 352, office management apps 354, sales and marketing apps 356, charitable apps 358, platform utility apps 360, and/or other apps 362. Generally, various different types of applications provided by the application computing system 320 may be organized, categorized, grouped, presented, and/or otherwise offered in any type of arrangement, and thus are not limited to any particular examples discussed herein, which are provided for illustration purposes only.

In an embodiment, collaboration apps 340 may include, for example, any applications that provide scheduling, communications, document sharing and management, electronic signature services, project management, productivity, and/or any other types of applications that facilitate work between individuals, groups, and/or parties.

In an embodiment, support apps 342 may include, for example, any applications that provide services associated with customer support, technical support, issue reporting, issue management and escalation, tracking and managing help desk tickets, and/or any other types of applications that facilitate customer, business, and/or technology support.

In an embodiment, design apps 344 may include, for example, any applications that provide services associated with creating graphic designs, product designs, prototypes, drawings, graphical user interfaces, user experiences, and/or any other types of applications that facilitate the creation of designs, interfaces, and/or artistic works.

In an embodiment, development apps 346 may include, for example, any applications that provide services associated with software development, software testing, source code control and management, source code scanning, application testing, process automation, cloud hosting and services, system monitoring, error reporting and alerts, machine learning, and/or any other types of applications that facilitate activities associated with building, maintaining, or deploying software applications.

In an embodiment, finance, operational, and legal apps 348 may include, for example, any applications that provide services associated with accounting systems, budgeting systems, vendor management systems, payment systems, travel systems, expense management systems, supply chain systems, manufacturing systems, compliance and governance systems, vendor management systems, contract management systems, and/or any other types of applications and/or systems used to manage various aspects of an organization.

In an embodiment, human resources (HR) and benefits apps 350 may include, for example, any applications that provide services associated with recruiting and hiring, temporary staffing, background checks, payroll and benefits, training and onboarding, retirement planning and contributions, reward and bonus programs, employee training, learning management systems, performance management, time and attendance, and/or systems any other types of applications or systems associated with employee-related activities.

In an embodiment, information technology (IT), device management, and security apps 352 may include, for example, any applications that provide services associated with device management, technology, information security, password management, and/or any activities associated with managing applications, systems, devices, or associated technology.

In an embodiment, office management apps 354 may include, for example, any applications that provide services associated with facilities management, receptionist services, physical access, visitor access, catering services, office layout, office assignments, and or any other types of applications or systems associated with performing office management.

In an embodiment, sales and marketing apps 356 may include, for example, any applications that provide services associated with social media, analytics, advertising, event management, customer relationship management, content creation and distribution, public relations, business generation, campaign management, and/or any other types of similar or related activities.

In an embodiment, charitable apps 358 may include, for example, any applications that provide services associated with donations, charitable giving, crowdfunding, etc.

In an embodiment, platform utility apps 360 may include, for example, any applications from a provider that allow an organization to utilize software applications, systems, or services that have been purchased or that are otherwise available from the provider. For example, a provider of an organizational data management system can allow an organization to access and utilize standard services and/or enhanced services one or more of the platform utility apps 360. In some embodiments, the platform utility apps 360 operate from and/or are directly integrated with applications, systems, and/or services obtained from a provider. For example, such platform utility apps 360 can allow one or more users of an organization to customize a particular implementation or instance of provider software that is associated with the organization. In one example, one of the platform utility apps 360 can allow the creation and/or modification of one or more custom fields in association with one or more entities, the creation and/or modification of one or more relationships among the entities, the creation and/or modification of one or more default system rules or custom rules, the addition and/or use of custom fields, custom relationships and/or custom rules in various workflow tasks, reports, integrations, etc.

In an embodiment, other apps 362 may include, for example, any types of applications that may be used by individuals and/or organizations. The other apps 362 may include, for example, any other category of integration applications 330 and/or any other types of applications that can be executed by a computing system or device.

In an embodiment, authorized users of an organization with the appropriate privileges may access one or more services of the application store computing system 320 directly, for example, via a website, web page, desktop application, mobile application, and/or any other type of application to browse, view, search, compare, evaluate, download, install, configure, upgrade, uninstall, and/or perform any other types of activities associated with the integration applications 330 or any other types of applications provided via the application store computing system 320. In some embodiments, authorized users of an organization with the appropriate privileges may access one or more services of the application store computing system 320 indirectly, for example, through another application (e.g., application 312) and/or another computing system (e.g., computing system 310). In some embodiments, the application store computing system 320 can be provided on the same computing system with other applications and services (e.g., running on computing system 310).

In an embodiment, any one or more users of an organization, such as an administrator, manager, or one or more other users associated with a particular role and/or one or more particular privileges each may install and/or configure each of one or more different integration applications 330 for use by the organization. For example, any such user with the appropriate privileges may install one or more of the integration applications 330 for the organization on the computing system 310 or any other computing systems or devices. Also, any such user with the appropriate privileges may configure software license data 314 associated with each of one or more integration applications 330. In some embodiments, one user with the appropriate privileges may delegate authority to one or more other users to perform installation and/or configuration of one or more of the integration applications for an organization.

In an embodiment, an organizational data management system is provided via at least one computing system to allow each of one or more different organizations to centrally manage their own organizational data 311. For example, the organizational data management system can be provided as a centralized system of record for storing and managing various types of organizational data 311 of an organization. The organizational data management system also can provide various types of integration across different third-party applications that utilize, that perform processing involving or based on, and/or that are otherwise associated with organizational data 311. The organizational data management system also can automate various processing based on the organizational data 311 including, but not limited to the automation of processing performed across various third-party applications based on the organizational data. In various embodiments, the organizational data management system can be provided via one or more different computing systems, one or more different applications, and/or via one or more different services, for example, to one or more different organizations over a computer network.

In an embodiment, a separate instance of an organizational data management system generally can be provided to each of one or more different organizations, for example to allow each organization to independently configure, manage, and integrate their own instance of an organizational data management system, and to secure and insulate organizational data 311 from outside parties. For example, separate instances of an organizational data management system generally may be provided to different organizations using different computer hardware devices, different software applications, different instances of software applications running in an isolated space, different databases, physically partitioned databases, and/or in various other ways.

In an embodiment, an organizational data management system generally enables organizations to efficiently manage organizational data 311 and associated processing that occurs based on the organizational data 311. For example, an organizational data management system may be used as a centralized system of record that is integrated with other computing systems and applications (e.g., third-party applications) that generate, utilize, process, or perform activities based on organizational data 311. Such integration generally allows an organizational data management system to orchestrate and automate processing of organizational data 311 and associated activities across numerous different applications that are not in communication with one another. In some embodiments, an organizational data management system can allow appropriate users (e.g., authenticated, authorized, privileged, etc.) of an organization to, for example, manage organization information, settings of an organizational data management system, onboarding of employees, offboarding of employees, employee information, organizational structure and locations, employee placement in departments and teams, workflows and tasks, reports, documents, and/or any other information associated with organizational data 311.

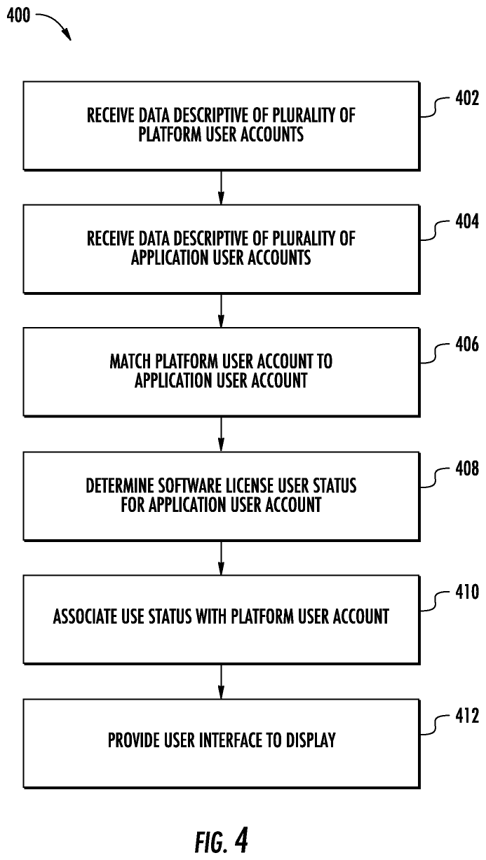

FIG. 4 depicts a flow diagram of an example method 400 for managing a plurality of software licenses, according to example embodiments of the present disclosure. Method 400 can be performed by a computing system, such as computing system 110, and can, in some example implementations, be performed in response to a user input, such as a user of the computing system selecting a “manage software licenses” button on a user interface, a user speaking “manage software licenses,” and/or other user input mechanisms.

At block 402, the computing system receives data descriptive of a plurality of platform user accounts. Platform user accounts can be user accounts associated with an organization management platform. The organization management platform is a software platform that allows for user data, such as platform user accounts, to be managed for users associated with an organization, such as employees. Platform user accounts are user profiles associated with the users, and can include such information as user name, user identification (“ID”), user password, user email address or electronic correspondence address, user home address, user phone number, user fax number, user identifying information such as age or birthday, user organization credentials, and the like. In some embodiments, the computing system receives all data associated with each platform user account. In other embodiments, the computing system may only receive a subset of data associated with each platform user account, such as only receiving user ID information, user email information, user credentials, and the like.

In some embodiments, the plurality of platform user accounts can be selected from a larger group of platform user accounts using a query or other search term. For example, a query can be run against a database of platform user accounts on the organizational management platform to find users associated with particular business teams, work groups, and the like. The set of platform user accounts that match the search criteria can then be provided as the plurality of platform user accounts to the computing system.

At block 404, the computing system receives data descriptive of a plurality of application user accounts. Application user accounts can include user accounts associated with a particular third-party software application, such as a code repository application, an email application, a financial application, a customer relationship management application, and the like. Like the platform user accounts, application user accounts are user profiles associated with users of the third-party software applications, and can include such information as user name, user identification, user password, user email address or electronic correspondence address, user home address, user phone number, user fax number, user identifying information such as age or birthday, user organization credentials, and the like. The application user accounts can also include software license or subscription information. For example, an application user account can include a software license identifier, a user associated with the license, license usage data, and the like.

In some embodiments, the computing system receives all data associated with each application user account. In other embodiments, the computing system may only receive a subset of data associated with each application user account, such as only receiving user ID information, user email information, user credentials, and the like.

At block 406, the computing system matches a platform user account of the plurality of platform user accounts to an application user account of the plurality of application user accounts. The computing system can perform matching in a variety of ways, such as evaluating one or more predefined matching rules.

The one or more predefined matching rules can be rules that are used to determine confidence scores associated with a particular candidate or potential match between a particular platform user account and a particular application user account. Any number of different predefined matching rules can be established and evaluated to attempt to matches a platform user account of the plurality of platform user accounts to an application user account of the plurality of application user accounts. For example, the matching performed at 406 can be a confidence building algorithm in which the number of different predefined matching rules are evaluated to build confidence toward a establishing certain match. For example, each predefined matching rule that is satisfied by a candidate or potential match can contribute a respective predefined amount of confidence (i.e., respective confidence weight) toward a total confidence associated with the candidate or potential match. If the total confidence exceeds a threshold value, then the candidate match can be established.

As one example of a predefined matching rule, a first matching rule can be a name matching rule. The computing system evaluates the name matching rule to determine if a user name associated with the platform user account meets or exceeds a threshold for matching a user name associated with the application user account. For example, if a user name of the platform user account is “John Doe” and a user name of the application user account is “John Doe,” the computing system can evaluate that the name matching rule is satisfied and that the two user names match. Based on the two user names matching, the computing system can calculate a confidence score of “100” or another similar value indicating a high likelihood of matching or that an exact match has been found.

In another example, the computing system can evaluate the name matching rule where the platform user account has a user name of “Johnny D” and the application user account has a user name of “Johnathan Doe.” The computing system can determine that the user names “match” because of similarities in the names, such as same root (“John”), same initials (“J” for a first initial, “D” for a second initial), known nicknames for full names (“John or “Johnny” as a nickname for “Johnathan”, e.g., as indicated in a look up table or other data structure storing name correspondences), and the like. In this instance, the computing system can determine a confidence score of “75” or another value indicating a likely match but with less certainty than an exact match of user names.

Other examples of matching rules can include rules for matching user identifying information (such as address, role, work team or group, seat assignment, and the like), rules for matching user email addresses or phone numbers, rules for matching IP addresses or computing device identifying information, rules for matching known collaborators (e.g., team members, work group members, etc.), rules for matching a number of characters in different string values, rules for matching a degree of location, and the like.

For example, for a rule for matching a degree of location, the computing system may compare a location (e.g., New York City) associated with the platform user account and a location associated with the application user account (e.g., New York). The computing system can determine if the locations match and to what degree the locations match, such as determining that the two locations match because both include “New York” or have coordinates, such as latitude and longitude, within a threshold distance of one another.

In another example, for a rule for matching computing device identifying information, the computing system can compare a device serial number or a list of device serial numbers associated with the platform user account to a device serial number of a list of device serial numbers associated with the application user account. If device serial number cannot be obtained, other device information, such as device make, model, processor specifications, and the like can be acquired and compared to other device information of devices associated with the application user account. In some embodiments, the computing system may have sub-rules for matching individual values associated with the device information, such as requiring that a certain threshold of device information values (manufacturer, model, processing capacity, on board RAM, etc.) match before determining a match between the platform user account and the application user account.

In yet another example, for a rule for matching known collaborators, the computing system may access a user role and/or a list of users on the same work team, seated near the same assigned seat, listed as working under the same manager, and the like. This user role and list of users can then be compared to a similar user role, list of users associated with a work team, list of users seated near a seat assignment, listed working under a same manager, and other values associated with the application user account. The computing system can compare these values to determine if they match (e.g., work under same manager, listed on same work team) or if they come within a threshold of matching (e.g., listed on same work team but not a complete match between every user on the work team, do not sit adjacent to one another but sit in a same area as one another in a building) to determine if the platform user account matches the application user account.

Different kinds of matching rules can have different weights assigned to the matching rules. For example, a user name matching rule may have a high weight, as a name matching between a platform user account and an application user account can better indicate that the same user is associated with both the platform user account and the application user account. In contrast, a user phone number matching rule may have a lower weight, as any confidence score not indicating “exact match” could mean the phone number does not match between the platform user account and the application user account (e.g., multiple phone numbers for users on the same work team may have the same area code and region code but different line numbers).

Based the calculated confidence scores for one or more evaluated matching rules and the associated weights, the computing system can determine if the platform user account and the application user account match (are associated with the same user). In one embodiment, each confidence score can be multiplied by the weight of the associated matching rule. After confidence scores are multiplied by weight, each confidence score can be summed into a total confidence score. The total confidence score can then be compared to a confidence score threshold. If the total confidence score exceeds the confidence score threshold, the computing system can determine that the user of the platform user account is the same user as the application user account.

In another embodiment, individual confidence scores associated with matching rules can be compared to individual comparison thresholds for each matching rule. For example, if a user name matching rule indicates that the user names for the platform user account and the application user account a 90% match, the computing system can compare this 90% match to a 75% comparison threshold. Because 90% is greater than the required 75% threshold, the computing system determines that the platform user account and the application user account are a match according to the user name matching rule. The computing system can then repeat this process for a number of other predefined matching rules, such as user email address matching rules, user profile photo matching rules, and the like. A number or percentage of the evaluated matching rules can then be compared to a threshold requirement of passed rules (e.g., must have at least 75% of evaluated rules indicate a match). If the number or percentage of the evaluated matching rules indicate a match, the computing system can determine that the platform user account and the application user account match.

In some implementations, in addition or alternatively to evaluation of pre-defined matching rules, at block 406, the computing system can use one or more machine learning models to match a platform user account of the plurality of platform user accounts to an application user account of the plurality of application user accounts. As one example, a machine learning model can be trained using semi-supervised learning techniques to embed both the platform user data and the application user data into a shared latent embedding space. A similarity (e.g., co-sine inner product, L1 or L2 distance, or other distance measure) can be evaluated to determine a similarity between a platform embedding generated from the platform user data and an application embedding generated from the application user data. If the similarity is sufficient (e.g., the distance is less than a threshold distance), then the platform user account can be matched with the application user account. For example, the above-described approach can be implemented using a dual encoder approach in which two encoder models (e.g., a platform encoder and an application encoder) are trained to (1) produce similar embeddings when respectively given platform user data and application user data known to belong to the same user; and (2) produce dissimilar embeddings when respectively given platform user data and application user data known to belong to the different users.

As another example, additionally or alternatively to the embedding-based approach described above, supervised learning techniques can be used to train a machine learning model to process a set of platform user data and a set of application user data to generate and output a classification or regression output that indicates a degree of confidence that the corresponding platform user account and application user account are associated with one another. For example, the model can be trained using training pairs that include a set of platform user data and a set of application user data and a label that indicates whether the training pair is a correct/true match or an incorrect/false match. Other machine learning approaches can be used as well such as a multi-class classifier that classifies the application user account against all available platform user accounts.

Referring still to FIG. 4, at block 408, the computing system determines a software license use status associated with the application user account. Each application user account can have a license or subscription to the third-party software application associated with the application user account. Each application user account can also track usage of the third-party software application by the user associated with the user. For example, the application user account can determine every time the user accesses the third-party software application, how long each access session is, what type of activity the user performs on the third-party software application, and the like. In some embodiments, a user's access of a third-party software application can be detected via a last log-in time data field associated with the application user account on the third-party software application, detecting a use of a “Single Sign-On” account for accessing the application user account of the third-party software application, and/or detecting the access and use of saved credentials (e.g., passwords) from a user credential data store to log in to the third-party software application. Use of “Single Sign-On” information and password access information can be particularly beneficial in situations in which third-party applications do not provide last log-in time data.

Based on the user's accesses of the third-party software application, a use status of the software license or subscription for the application user account can be determined. For example, if the user accesses the third-party software application at least once a day, the use status of the software license can be “active” or “in use.” In another example, if the user hasn't logged in for 30 days, the use status of the software license can be “inactive” or “not used.” In some embodiments, the use status can be more granular than “active” or “inactive.” For example, if a user accesses the third-party software once every work week, the use status of the software license can be “infrequently used” or “rarely used,” while users that access the third-party software application every day or every other day may have a software license use status of “frequently used” or “daily user.”

At block 410, the computing system associates the use status of the software license or subscription with the matched platform user account. In some embodiments, the computing system can generate a link (e.g., directly or indirectly within a data graph) to the use status of the software license and store the link as data associated with the platform user account. In other embodiments, the computing system can set a value of a field or a property associated with the platform user account to a value matching the use status of the software license or subscription.

At block 412, the computing system provides a user interface for display to a user. The user interface includes information related to use statuses of software licenses associated with the plurality of platform user accounts. For example, the user interface can include a summary of software licenses owned by the organization, a summary of the use statuses of the software licenses owned by the organization (e.g., a number of licenses in use, a number of licenses not in use, and the like), percentages of licenses in use, price of licenses with an “inactive” or “not in use” status, efficiency metrics associated with the use statuses (e.g., a number or percentage of users that are frequently using the license and a number or percentage of users not frequently using the license), and other statistics.

In some embodiments, the user interface can also include user controls for managing software licenses. For example, the user interface can include a user input mechanism, such as a button, that can receive a user input. In response to receiving the user input, the user input mechanism can initiate a control to manage software licenses. In some embodiments, the control generates a new window that provides a second user interface showing additional details regarding usage data of the software licenses for a particular third party application. The second user interface can include user input mechanisms that can receive a user input, such as buttons, that, when an input receive, takes one or more automatic actions associated with the software licenses, such as canceling licenses for users that have not accessed the third-party software application in a predefined amount of time, sending messages to users who are infrequent users of the third-party application to inquire about their continuing need for a license, suspending access to the third-party application for users, renewing licenses frequently in use, and the like. In other embodiments, the controls described above can be presented on the first user interface.

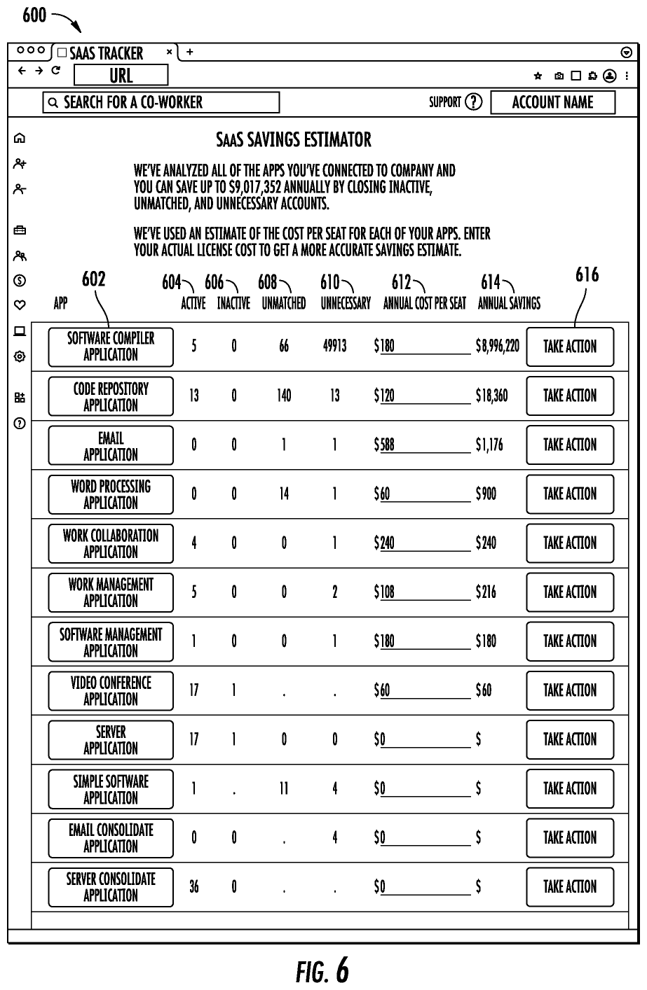

Additional details regarding the user interface can be found below with regards to FIG. 6.

In addition, in some implementations, the method 400 can alternatively or additionally include automatic actions taken on the basis of the use statuses determined for the software licenses. For example, the computing system can operate to communicate (e.g., via an API) with one or more third-party applications to automatically cancel or suspend application user accounts that are determined to have a certain status (e.g., inactive). In another example, once matched, actions taken with respect to a platform user account can automatically result in corresponding actions taken with respect to an application user account that has been matched (e.g., as described herein) to the platform user account. For example, termination of a platform user account can automatically result in cancellation of a software license for an application user account that has been matched with the platform user account. In some implementations, these automatic operations can be performed in accordance with one or more query rules (e.g., user-defined query rules) that have been written in a custom query language.

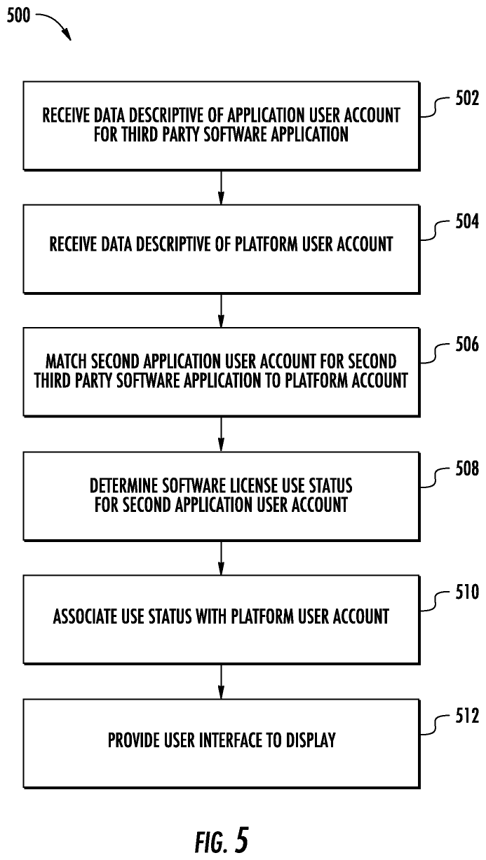

FIG. 5 depicts a flow diagram of an example method 500 for matching user accounts based on information associated with the user accounts, according to example embodiments of the present disclosure. In some embodiments, method 500 is performed in response to a user input requesting matching between user accounts. In other embodiments, method 500 can be performed automatically as part of a schedule of processes to be executed by one or more computing systems.

At block 502, a computing system receives, from a first third-party software application, data descriptive of a first application user account associated with a user. For example, the computing system can receive such information as user name, user identification, user password, user email address or electronic correspondence address, user home address, user phone number, user fax number, user identifying information such as age or birthday, user organization credentials, and the like. The first application user accounts can also include software license or subscription information. For example, a first application user account can include a software license identifier, a user associated with the license, license usage data, and the like. In some embodiments, the first third-party software application can be an email application, a code repository application, a customer relationship management application, and the like.

At block 504, the computing system receives, from an organization management platform, data descriptive of a platform user account associated with the user. The platform user account can be a user account associated with the organization management platform. The organization management platform is a software platform that allows for user data, such as platform user accounts, to be managed for users associated with an organization, such as employees. The platform user account can be a user profile associated with the user and can include such information as user name, user identification (“ID”), user password, user email address or electronic correspondence address, user home address, user phone number, user fax number, user identifying information such as age or birthday, user organization credentials, and the like.

At block 506, the computing system matches a second application user account for a second third-party software application associated with the user to the platform user account associated with the user based on the data descriptive of the first application user account and the data descriptive of the platform user account.

For example, the computing system can compare a user name of the first application user account and a user name of the platform user account to a list of user names of application user accounts for a second software application. The computing system can search for matches (e.g., exact matches or partial matches) among the user names of application user accounts for the second software application. Based on the search for matches, the computing system can determine an application user account associated with the second third-party software application that belongs to the same user as the application user account associated with the first third-party software application and the platform user account.

In a specific example, the computing system can compare the username “JohnDoe,” associated with a code repository software application user account and the username “JohnD” associated with a platform user account and determine that these usernames are a match. After this determination, the computing system can compare the matched usernames to a set of usernames associated with user accounts for a video conferencing software application. The computing system can identify that a user account for the video conferencing software application has a username “JDoe1.” Based on the matched usernames of “JohnDoe” and “JohnD,” the computing system can determine that the user account on the video conferencing software application (“JDoe1”) is a match because the initials are the same (“J” and “D”), had a same last name as one of the matched usernames (“Doe”), and includes a commonly added character to usernames (“1”). Based on these rules, the computing system can determine that the user account for the video conferencing software application matches the user account associated with the code repository software application and the platform user account.

In some embodiments, the computing system can perform matching in a variety of ways, such as evaluating one or more predefined matching rules.

The one or more predefined matching rules can be rules that are used to determine confidence scores. For example, a first matching rule can be a name matching rule. The computing system evaluates the name matching rule to determine if a user name associated with the first application user account and the platform user account meets or exceeds a threshold for matching a user name associated with the second application user account. For example, if a user name of the platform user account is “John Doe,” the user name of the first application user account is “John Doe,” and a user name of the second application user account is “John Doe,” the computing system can evaluate that the name matching rule is satisfied and that the user names match. Based on the user names matching, the computing system can calculate a confidence score of “100” or another similar value indicating a high likelihood of matching or that an exact match has been found.

In another example, the computing system can evaluate the name matching rule where the platform user account has a user name of “John D,” the first application user account has a user name of “John,” and the second application user account has a user name of “Johnathan Doe.” The computing system can determine that the user names “match” because of similarities in the names, such as same root (“John”), same initials (“J” for a first initial, “D” for a second initial), known nicknames for full names (“John or “Johnny” as a nickname for “Johnathan”), and the like. In this instance, the computing system can determine a confidence score of “75” or another value indicating a likely match but with less certainty than an exact match of user names.

Other examples of matching rules can include rules for matching user identifying information (such as address, role, work team or group, seat assignment, and the like), rules for matching user email addresses or phone numbers, rules for matching IP addresses or computing device identifying information, rules for matching known collaborators (e.g., team members, work group members, etc.), and the like, for example, as discussed above with respect to block 406 of FIG. 4.

Different kinds of matching rules can have different weights assigned to the matching rules. For example, a user name matching rule may have a high weight, as a name matching between a platform user account and the application user accounts can better indicate that the same user is associated with the platform user account, the first application user account, and the second application user account. In contrast, a user phone number matching rule may have a lower weight, as any confidence score not indicating “exact match” could mean the phone number does not match between the platform user account, the first application user account, and the second application user account (e.g., multiple phone numbers for users on the same work team may have the same area code and region code but different line numbers).

Based the calculated confidence scores for one or more evaluated matching rules and the associated weights, the computing system can determine if the platform user account, the first application user account, and the second application user account match (are associated with the same user). In one embodiment, each confidence score can be multiplied by the weight of the associated matching rule. After confidence scores are multiplied by weight, each confidence score can be summed into a total confidence score. The total confidence score can then be compared to a confidence score threshold. If the total confidence score exceeds the confidence score threshold, the computing system can determine that the user of the platform user account is the same user as the application user accounts.

In another embodiment, individual confidence scores associated with matching rules can be compared to individual comparison thresholds for each matching rule. For example, if a user name matching rule indicates that the user names for the platform user account, the first application user account, and the second application user account are a 90% match, the computing system can compare this 90% match to a 75% comparison threshold. Because 90% is greater than the required 75% threshold, the computing system determines that the platform user account and the application user accounts are a match according to the user name matching rule. The computing system can then repeat this process for a number of other predefined matching rules, such as user email address matching rules, user profile photo matching rules, and the like. A number or percentage of the evaluated matching rules can then be compared to a threshold requirement of passed rules (e.g., must have at least 75% of evaluated rules indicate a match). If the number or percentage of the evaluated matching rules indicate a match, the computing system can determine that the platform user account and the application user accounts match.

In some implementations, in addition or alternatively to evaluation of pre-defined matching rules, at block 506, the computing system can use one or more machine learning models to match a platform user account of the plurality of platform user accounts to an application user account of the plurality of application user accounts. As one example, a machine learning model can be trained using semi-supervised learning techniques to embed both the platform user data and the application user data into a shared latent embedding space. A similarity (e.g., co-sine inner product, L1 or L2 distance, or other distance measure) can be evaluated to determine a similarity between a platform embedding generated from the platform user data and an application embedding generated from the application user data. If the similarity is sufficient (e.g., the distance is less than a threshold distance), then the platform user account can be matched with the application user account. For example, the above-described approach can be implemented using a dual encoder approach in which two encoder models (e.g., a platform encoder and an application encoder) are trained to (1) produce similar embeddings when respectively given platform user data and application user data known to belong to the same user; and (2) produce dissimilar embeddings when respectively given platform user data and application user data known to belong to the different users. In another example, matching an application account to a platform account can include accessing a stored association automatically created upon automatic initiation of the application account by the organizational platform.

As another example, additionally or alternatively to the embedding-based approach described above, supervised learning techniques can be used to train a machine learning model to process a set of platform user data and a set of application user data to generate and output a classification or regression output that indicates a degree of confidence that the corresponding platform user account and application user account are associated with one another. For example, the model can be trained using training pairs that include a set of platform user data and a set of application user data and a label that indicates whether the training pair is a correct/true match or an incorrect/false match. Other machine learning approaches can be used as well such as a multi-class classifier that classifies the application user account against all available platform user accounts.

Referring still to FIG. 5, at block 508, the computing system determines, for a software license associated with the second application user account, a use status of the software license based on data associated with the second application user account. Each application user account can have a license or subscription to the third-party software application associated with the application user account. Each application user account can also track usage of the third-party software application by the user associated with the user. For example, the application user account can determine every time the user accesses the third-party software application, how long each access session is, what type of activity the user performs on the third-party software application, and the like.

Based on the user's accesses of the third-party software application, a use status of the software license or subscription for the application user account can be determined. For example, if the user accesses the third-party software application at least once a day, the use status of the software license can be “active” or “in use.” In another example, if the user hasn't logged in for 30 days, the use status of the software license can be “inactive” or “not used.” In some embodiments, the use status can be more granular than “active” or “inactive.” For example, if a user accesses the third-party software once every work week, the use status of the software license can be “infrequently used” or “rarely used,” while users that access the third-party software application every day or every other day may have a software license use status of “frequently used” or “daily user.”

At block 510, the computing system associates the use status of the software license of the second application user account with the at least one platform user account matched with the second application user account. In some embodiments, the computing system can generate a link to the use status of the software license and store the link as data associated with the platform user account. In other embodiments, the computing system can set a value of a field or a property associated with the platform user account to a value matching the use status of the software license or subscription.

At block 512, the computing system provides a user interface for display, the user interface indicating the use status of the software license in association with the platform user account. The user interface includes information related to use statuses of software licenses for the user. For example, the user interface can include a summary of software licenses owned by the user (e.g., a number of licenses in use, a number of licenses not in use, and the like), percentages of licenses in use, price of licenses with an “inactive” or “not in use” status, efficiency metrics associated with the use statuses, and other statistics.

In addition, in some implementations, the method 500 can alternatively or additionally include automatic actions taken on the basis of the use statuses determined for the software licenses. For example, the computing system can operate to communicate (e.g., via an API) with one or more third-party applications to automatically cancel or suspend application user accounts that are determined to have a certain status (e.g., inactive). In another example, once matched, actions taken with respect to a platform user account can automatically result in corresponding actions taken with respect to an application user account that has been matched (e.g., as described herein) to the platform user account. For example, termination of a platform user account can automatically result in cancellation of a software license for an application user account that has been matched with the platform user account. In some implementations, these automatic operations can be performed in accordance with one or more query rules (e.g., user-defined query rules) that have been written in a custom query language.

FIG. 6 illustrates an example user interface 600, according to example embodiments of the present disclosure. In some embodiments, the user interface 600 can be generated by a computing system in response to one or more user accounts being matched to software licenses, such as in methods 400 or 500 as described above.

The user interface 600 can include a list 602 of third-party software applications associated with (e.g., used by) an organization. The user interface 600 can also include various elements, such as number 604 of active licenses, a number 606 of inactive licenses, a number 608 of unmatched licenses, a number 610 of unnecessary licenses, an amount 612 of per-unit cost of licenses, and an amount 614 that can be saved by the organization can be displayed along with the list 602 of third-party software applications. In some implementations, the various elements can be selectable elements that, when selected, the computing system causes the user interface 600 to display additional information about that element, such as a breakdown of the number 610 of unnecessary licenses and a list of users the unnecessary licenses are associated with.

In some implementations, the amount 612 of per-unit cost of each license can be manually entered by a user of the system. Additionally or alternatively, the organizational computing system can automatically determine the amount 612 of per-unit cost of licenses. As an example, the organizational computing system can evaluate expense management data to determine the amount 612 of per-unit cost of licenses. For example, expense entries can be matched to specific software products/applications to determine a per-unit cost of each license for the product.

In some implementations, the user interface 600 can also include one or more user input mechanisms 616, such as selectable boxes or other controls, that allows users accessing the user interface 600 to take actions related to managing the third-party software applications, such as removing unnecessary licenses, manually connecting licenses to users, and the like.

For example, if a use status element of the user interface is selected, the computing system can cause the user interface 600 to display a sorted list of software licenses, the sorted list being sorted based on frequency, inverse frequency, and the like of various statuses, such as the selected status (e.g., when an unused status is selected, the sorted list is returned with the software application with the most unused software licenses as the first element in the list). In another example, if a cost element is selected, the computing system can cause the user interface 600 to display a sorted list of software licenses, the sorted list being sorted based on a total cost to the organization from unused/unnecessary/inactive statuses, based on individual license cost, and the like.

In a further example, if a user selects a user input mechanism associated with a video conferencing software application, the computing system can generate a second user interface and provide the second user interface for display. The second user interface can include various elements, such a list of all user accounts associated with the video conferencing software applications, various user interface features such as columns illustrating use statuses of licenses associated with the video conferencing software applications, a list of users that fall under specific categories of software license use status, and the like. The various elements of the second user interface can be selectable elements such that, in response to being selected, the computing system causes one or more actions associated with the selected element to be performed. For example, if a number of licenses that are unused are selected, the computing system can cause one or more alerts to be sent to users associated with the unused licenses, can cause the second user interface to display a list of users associated with the unused use status, and the like. As another example, the user interface can provide an option for a user to choose an automated action to be performed with respect to a certain license or group of licenses. For example, the user can be presented with the option of canceling any licenses that have a use status of “inactive” or similar. If selected, the organizational computing system and platform can automatically operate to communicate (e.g., via an API) with the corresponding third-party application to cause cancellation of the corresponding application software license.

Numerous details are set forth in the foregoing description. However, it will be apparent to one of ordinary skill in the art having the benefit of this disclosure that the present disclosure may be practiced without these specific details. In some instances, structures and devices are shown in block diagram form, rather than in detail, to avoid obscuring the present disclosure.

Some portions of the detailed description have been presented in terms of processes and symbolic representations of operations on data bits within a computer memory. Here, a process can include a self-consistent sequence of steps leading to a result. The steps can include those requiring physical manipulations of physical quantities. These quantities can take the form of electrical or magnetic signals capable of being stored, transferred, combined, compared, and otherwise manipulated. These signals can be referred to as bits, values, elements, symbols, characters, terms, numbers, or the like.

These terms and similar terms can be associated with physical quantities and can represent labels applied to these quantities. The terms including “analyzing,” “accessing,” “determining,” “identifying,” “adjusting,” “modifying,” “transmitting,” “receiving,” “processing” “generating,” or the like, can refer to the actions and processes of a computer system, a computing device, or similar electronic computing device, that manipulates and transforms data represented as physical (e.g., electronic) quantities within the computer system's registers and memories into other data that can be similarly represented as physical quantities within the computer system's memories, registers, or other information storage device, data transmission device, or data processing device.

Certain examples of the present disclosure can relate to an apparatus for performing the operations described herein. This apparatus may include a computing device that is activated or reconfigured by a computer program comprising electronic instructions stored in the computing device. Such a computer program may be stored in a computer readable storage medium, which can include any type of storage. For example, the storage can include hard disk drives, solid state drives, floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The above description is intended to be illustrative, and not restrictive. The scope of the disclosure can therefore be determined with reference to the claims.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for managing a plurality of software licenses, the method comprising:
receiving, from an organizational management platform, data descriptive of a plurality of platform user accounts;
receiving, from a third-party software application, data descriptive of a plurality of application user accounts;
matching at least one platform user account of the plurality of platform user accounts to at least one application user account of the plurality of application user accounts, wherein matching the at least one platform user account and the at least one application user account indicates that the at least one platform user account and the at least application user account are associated with the same user;
determining, for a software license associated with the at least one application user account, a use status of the software license based on data associated with the application user account;
associating the use status of the software license with the at least one platform user account matched with the at least one application user account; and
providing a user interface for display, the user interface indicating the use status of the software license in association with the platform user account.

2. The computer-implemented method of claim 1, wherein matching the at least one platform user account to the at least one application user account includes:
evaluating one or more predefined matching rules;
determining a confidence score based on the evaluation of the one or more predefined matching rules;
performing a first comparison of the determined confidence score to a confidence threshold; and
determining the matching of the at least one platform user account and the at least one application user account based on the first comparison.

3. The computer-implemented method of claim 2, wherein evaluating the one or more predefined matchings rules includes:
obtaining data descriptive of the platform user account;
obtaining data descriptive of the application user account;
performing a second comparison between data descriptive of the platform user account and the data descriptive of the application user account; and
determining the confidence score at least in part based on the second comparison.

4. The computer-implemented method of claim 3, wherein evaluating the one or more predefined matching rules further includes:
determining a weight associated with each predefined matching rule of the one or more predefined matching rules; and
determining the confidence score at least in part based on the weight associated with at least one predefined matching rule of the one or more predefined matching rules.

5. The computer-implemented method of claim 4, wherein determining the confidence score at least in part based on the weight associated with the at least one predefined matching rule of the one or more predefined matching rules includes:
determining a rule-specific confidence score based on the weight associated with the at least one predefined matching rule of the one or more predefined matching rules;
performing a third comparison of the rule-specific confidence score to a rule-specific confidence threshold; and
determining the confidence score based at least in part on the third comparison.

6. The computer-implemented method of claim 1, wherein providing the user interface for display includes:
determining a summary of use statuses associated with a subset of the plurality of platform user accounts;
determining one or more statistics associated with the summary of use statuses; and
providing for display the summary of use statuses and the one or more statistics associated with the summary of use statuses.

7. The computer-implemented method of claim 1, wherein providing the user interface for display includes:
providing a user control at the user interface, the user control configured to receive a user input associated with one or more actions to be performed for the application user account matched with the platform user account associated with the use status.

8. The computer-implemented method of claim 7, the computer-implemented method further comprising:
receiving a user input from the user control; and
performing the one or more actions to be performed for the application user account matched with the platform user account associated with the use status in response to receiving the user input from the user control.

9. The computer-implemented method of claim 1, the computer-implemented method further comprising:
performing one or more automatic actions in response to associating the use status of the software license with the at least one platform user account matched with the at least one application user account.

10. The computer-implemented method of claim 9, the one or more automatic actions including at least one action selected from the group of actions consisting of deactivating the application user account, unsubscribing the application user account from the third-party software application, confirming the subscription of the application user account to the third-party software application, and suspending the application user account from using the third-party software application.

11. A non-transitory, computer-readable medium comprising instructions that, when executed by one or more processors, cause the one or more processors to perform operations, the operations including:
receiving, from an organizational management platform, data descriptive of a plurality of platform user accounts;
receiving, from a third-party software application, data descriptive of a plurality of application user accounts;
matching at least one platform user account of the plurality of platform user accounts to at least one application user account of the plurality of application user accounts, wherein matching the at least one platform user account and the at least one application user account indicates that the at least one platform user account and the at least application user account are associated with the same user;
determining, for a software license associated with the at least one application user account, a use status of the software license based on data associated with the application user account;
associating the use status of the software license with the at least one platform user account matched with the at least one application user account; and
providing a user interface for display, the user interface indicating the use status of the software license in association with the platform user account.

12. The non-transitory, computer-readable medium of claim 11, wherein matching the at least one platform user account to the at least one application user account includes:
evaluating one or more predefined matching rules;
determining a confidence score based on the evaluation of the one or more predefined matching rules;
performing a first comparison of the determined confidence score to a confidence threshold; and
determining the matching of the at least one platform user account and the at least one application user account based on the first comparison.

13. The non-transitory, computer-readable medium of claim 12, wherein evaluating the one or more predefined matchings rules includes:
obtaining data descriptive of the platform user account;
obtaining data descriptive of the application user account;
performing a second comparison between data descriptive of the platform user account and the data descriptive of the application user account; and
determining the confidence score at least in part based on the second comparison.

14. The non-transitory, computer-readable medium of claim 13, wherein evaluating the one or more predefined matching rules further includes:
determining a weight associated with each predefined matching rule of the one or more predefined matching rules; and
determining the confidence score at least in part based on the weight associated with at least one predefined matching rule of the one or more predefined matching rules.

15. The non-transitory, computer-readable medium claim 14, wherein determining the confidence score at least in part based on the weight associated with the at least one predefined matching rule of the one or more predefined matching rules includes:
determining a rule-specific confidence score based on the weight associated with the at least one predefined matching rule of the one or more predefined matching rules;
performing a third comparison of the rule-specific confidence score to a rule-specific confidence threshold; and
determining the confidence score based at least in part on the third comparison.

16. The computer-implemented method of claim 1, wherein providing the user interface for display includes:
determining a summary of use statuses associated with a subset of the plurality of platform user accounts;
determining one or more statistics associated with the summary of use statuses; and
providing for display the summary of use statuses and the one or more statistics associated with the summary of use statuses.

17. A computing system having one or more processors that are communicatively coupled to one or more non-transitory computer-readable media with instructions that, when executed by the one or more processors, cause the one or more processors to perform operations for matching user accounts across multiple third-party software applications, the operations comprising:
receiving, from a first third-party software application, data descriptive of a first application user account associated with a user;
receiving, from an organization management platform, data descriptive of a platform user account associated with the user;
matching a second application user account for a second third-party software application associated with the user to the platform user account associated with the user based on the data descriptive of the first application user account and the data descriptive of the platform user account, wherein matching the second application user account with the platform user account indicates that the second application user account, the first application user account, and the platform user account are associated with the same user;
determining, for a software license associated with the second application user account, a use status of the software license based on data associated with the second application user account;
associating the use status of the software license with the at least one platform user account matched with the second application user account; and
providing a user interface for display, the user interface indicating the use status of the software license in association with the platform user account.

18. The computing system of claim 17, wherein matching the second application user account to the platform user account includes:
evaluating at least a first rule of one or more predefined matching rules;
determining a confidence score based on the evaluation of the first rule;
performing a first comparison of the determined confidence score to a confidence threshold; and
determining the matching of the platform user account and second application user account based at least in part on the first comparison.

19. The computing system of claim 18, wherein matching the second application user account to the platform user account further includes:
receiving data descriptive of a third application user account for a third third-party software application associated with a user;
evaluating a second rule of the one or more predefined matching rules based on the data descriptive of the third application user account;
updating the confidence score based on the evaluation of the second rule;
performing a second comparison of the updated confidence score to the confidence threshold; and
determining the matching of the platform user account and second application user account based at least in part on the first comparison and the second comparison.

20. The computing system of claim 18, wherein evaluating the first rule includes:
determining a weight associated with the first rule; and
determining the confidence score at least in part based on the weight associated with the first rule.
